(19) United States
(12) Patent Application Publication
(10) Pub. No.: US 2007/0278304 A1
(43) Pub. Date: Dec. 6, 2007

(54) SYSTEM AND METHOD FOR COLLECTING AND DISTRIBUTING INFORMATION AND FOR BILLING ACCORDING TO DISTRIBUTION TIMES

(75) Inventor: Wei Shen, Beijing (CN)

Correspondence Address: AKERMAN SENTERFITT, P.O. BOX 3188, WEST PALM BEACH, FL, 33402-3188, US

(73) Assignee: Gmedia Corporation, George Town, Grand Cayman (KY)

(21) Appl. No.: 11/755,312

(22) Filed: May 30, 2007

(30) Foreign Application Priority Data
May 30, 2006 (CN) 200610083105.3

(51) Int. Cl. G06K 7/10

(52) U.S. Cl. 235/462.01

(57) ABSTRACT

The present invention discloses a method for collecting information for distribution and billing based on distribution times. The method comprises collecting barcode information and information for distribution for an information distributing server via an information inputting terminal; associating the barcode information with the information for distribution according to a predetermined associating mechanism; reading the barcode information on an information carrier with a mobile terminal and sending the read barcode information to the information distributing server; distributing the information for distribution to the mobile terminal in response to a matching between the received barcode information and the pre-stored barcode information which is associated with the information for distribution; and performing statistic on the distribution times of the information for distribution, and billing according to a predetermined charging mechanism, wherein the information distributing server, the mobile terminal and information inputting terminal are coupled in a network. By using the method provided in this invention, the charging for information distribution may be more efficient and flexible.

### BACKGROUND OF THE INVENTION

1. Field of the Invention

The present invention relates to collecting and distributing information with mobile communication terminals (especially mobile phones) and a network; relates to information writing and reading to information carriers; and relates to a system and a method of performing statistics on distribution times and billing based on the distribution times.

2. Description of the Related Art

Recently, Internet has been widely used, and accessing Internet through mobile phones is also popularized gradually. People can enjoy a variety of services through Internet, such as shopping, booking hotels, and browsing information. Meanwhile, papers, magazines and posters are publishing more and more advertisements with URLs to direct people to access related web pages and obtain more information.

However, to access a network, a user has to perform operations such as inputting URLs on a terminal device and so on. For a mobile phone user, such complicated operations for accessing the network are quite cumbersome. However, for a computer terminal which is relatively convenient for the operation of inputting the URLs, it is often the case that the user does not take along the computer terminal when he is reading the advertisements. Therefore, this would impact the effect of advertising and promoting using URLs.

Due to the development of camera mobile phones, the application of identifying barcodes (including one-dimensional codes, two-dimensional codes and the like) via camera lens of mobile phones and obtaining related information from a network is increasing. That is, to carry barcodes on printed matters, identify the barcodes via the camera lens of the mobile phones, and obtain information from the network. Another application is to identify barcodes on commodities by camera lens of mobile phones and obtain information related to the commodities from a database through a network. However, all these applications do not relate to the method of billing according to information distribution times (i.e., times of acquiring the information from the network by users).

The patent document PCT/CN/2005/001778, owned by the applicant of this application, describes a method of distributing information with a search engine and sorting by bid prices, in which, an information distributor transmits information to be distributed, barcodes information or product information represented by the barcodes to an information distributing server, and a barcode managing module associates the barcodes with the information for distribution, and sets prices for information clicking and displaying. When a user scans a barcode and the barcode information obtained is the same as the barcode information in the barcode managing module, a part or all of the information for distribution associated with the barcode will be displayed, and the information for distribution associated with the same barcode is sorting according to the payments for each click and information display of the information distributors.

What is described in this document is to charge according to payment of each click and to sort according to bid price of each click, i.e., charging only when a user clicks a piece of information. But the charging to information distribution directed by the barcode, no matter if there is a user clicking on the information content, is not considered.

### SUMMARY OF THE INVENTION

With respect to the drawbacks and disadvantages in the prior art, the purpose of the present invention is to provide a system and a method of collecting information for distribution with a terminal and billing according to distribution times, wherein a user reads information on a barcode and accesses to a network for distributed information, while a service provider charges according to distribution times. By using this method, an information distributor may display his information to users who need the information in the information distribution related to his products and services, while a user may obtain desired information by reading barcodes on products, media and advertisements with photographic means of a mobile phone, and an information distribution service provider may charge the information distributor or the mobile terminal user according to the information distribution times.

To achieve the purpose mentioned above, the present invention provides a system of collecting information for distribution with a terminal and billing according to distribution times, comprising:

an information carrier for carrying barcode information;

a mobile communication terminal for reading the information on the information carrier;

an information inputting terminal for transmitting information to be distributed and barcode information to an information distributing server;

an information distributing server having a barcode managing module therein, the barcode managing module associating the barcode information with the information for distribution;

transmitting the information to be distributed and barcode information to the information distributing server through the information inputting terminal, and the barcode managing module associating the barcode information with the information for distribution; the mobile communication terminal reading the barcode information on the information carrier, and when the barcode information obtained is the same as the barcode information in the barcode managing module, the information for distribution associated with the barcode being partially or fully displayed on the mobile communication terminal through a network; the information distributing server performing statistics on the distribution times of the information for distribution associated with the barcode, and billing according to a pre-set charging table based on the distribution times.

Preferably, in the system of collecting information for distribution with a terminal and billing according to distribution times, the barcode managing module comprises a storage module for storing the barcode information and the information for distribution.

Preferably, in the system of collecting information for distribution with a terminal and billing according to distribution times, the barcode managing module further comprises a matching module for matching the received barcode information to one or more storage records in the information distributing server.

Preferably, in the system of collecting information for distribution with a terminal and billing according to distribution times, the barcode managing module comprises a statistic block for performing statistics on the times which the information for distribution directed by the barcode has been accessed.

Preferably, in the system of collecting information for distribution with a terminal and billing according to distribution times, the barcode managing module comprises a charging block for setting various charging formulas or tables which are based on the information distribution times, and calculating the charging result.

Preferably, in the system of collecting information for distribution with a terminal and billing according to distribution times, the mobile communication terminal includes an information reading apparatus.

Preferably, in the system of collecting information for distribution with a terminal and billing according to distribution times, the information reading apparatus is a photoelectric reading apparatus such as a digital camera, a barcode identifying device and the like.

A method of collecting information for distribution with a terminal and billing according to distribution times, comprising the following steps:
step 1, transmitting information to be distributed and barcode information to an information distributing server through an information inputting terminal;
step 2, a barcode managing module associating the barcode information with the information for distribution;
step 3, a mobile communication terminal reading barcode information on an information carrier;
step 4, the mobile communication terminal sending the barcode information to the information distributing server through a network;
step 5, the barcode managing module matching the received barcode information sent by the mobile communication terminal to barcode information stored by its own to determine if they are the same;
step 6, if they are the same, the barcode managing module sending the information for distribution associated with the barcode information to the mobile communication terminal;
step 7, the barcode managing module performing statistics on the distribution times of the information for distribution associated with the barcode information, and billing according to a pre-set charging table based on the distribution times.

Due to the gradual popularity of the mobile phones with photographic means, identifying a barcode by the photographic means and accessing a network to obtain information is a convenient and fast manner for accessing the network. By the billing method for information distribution of the present invention, an information distributor may display his information to users who need the information in the information distribution related to his products and services; while a user may obtain desired information by reading barcodes with photographic means of a mobile phone; additionally, a service provider may charge the information distributor or the mobile terminal user according to the information distribution times.

According to one aspect of the present invention, a method for collecting information for distribution and billing based on distribution times is provided, which comprises collecting barcode information and information for distribution for an information distributing server via an information inputting terminal; associating the barcode information with the information for distribution according to a predetermined associating mechanism; reading the barcode information on an information carrier with a mobile terminal and sending the read barcode information to the information distributing server; distributing the information for distribution to the mobile terminal in response to a matching between the received barcode information and the pre-stored barcode information which is associated with the information for distribution; and performing statistic on the distribution times of the information for distribution, and billing according to a predetermined charging mechanism, wherein the information distributing server, the mobile terminal and information inputting terminal are coupled in a network.

According to another aspect of the present invention, a system for collecting information for distribution and billing based on distribution times is provided, which comprises an information carrier for carrying barcode information; a mobile terminal for reading and sending the barcode information on the information carrier; an information inputting terminal for collecting barcode information and information for distribution for an information distributing serve; an information distributing server for associating the collected barcode information with the information for distribution according to a predetermined associating mechanism, for distributing the information for distribution to the mobile terminal in response to a matching between the received barcode information and the pre-stored barcode information which is associated with the information for distribution, and for performing statistic on the distribution times of the information for distribution, and billing according to a predetermined charging mechanism, wherein the information distributing server, the mobile terminal and the information inputting terminal are coupled in a network.

The information distributing server in the system may further comprise an associating block within a barcode manage module for associating the collected barcode information with the information for distribution. The information distributing server may further comprise a statistic block within a barcode manage module for performing statistic on the distribution times of the information for distribution. The information distributing server may further comprise a charging block within a barcode manage module for performing the billing operation.

The predetermined charging mechanism may comprise one of charging by unequal payments, charging by descending payments, charging by incremental payments, charging by progressive descending payments, charging by progressive incremental payments, charging by a fixed total payment and any combination thereof, and the predetermined associating mechanism may comprise one-to-one relationship.

### BRIEF DESCRIPTION OF THE DRAWINGS

In order to understand the manner in which embodiments of the present invention are obtained, a more particular description of various embodiments of the invention briefly described above will be rendered by reference to the appended drawings. Understanding that these drawings depict only typical embodiments of the invention that are not necessarily drawn to scale and are not therefore to be considered to be limited of its scope, the embodiments of the invention will be described and explained with additional specificity and detail through the use of the accompanying drawings in which:

FIG. 1 is a block diagram illustrating the present invention;

FIG. 2 shows barcode patterns in accordance with the present invention;

FIG. 3 is a block diagram of a system for collecting information for distribution and billing based on distribution times in accordance with the present invention; and

FIG. 4 is a flow chart showing a method for collecting information for distribution and billing based on distribution times in accordance with the present invention.

### DETAILED DESCRIPTION OF THE INVENTION

In the following description, numerous details are set forth. It will be apparent, however, to one skilled in the art, that the present invention may be practiced without these specific details. In other instances, well-known structures and devices are shown in block diagram form, rather than in detail, in order to avoid obscuring the present invention.

The present invention provides a system of collecting information for distribution with a terminal and billing according to distribution times, comprising:

an information carrier for carrying barcode information;

a mobile communication terminal for reading the information on the information carrier;

an information inputting terminal for transmitting information to be distributed and barcode information to an information distributing server;

an information distributing server having a barcode managing module therein, the barcode managing module associating the barcode information with the information for distribution;

transmitting the information to be distributed and barcode information to the information distributing server through the information inputting terminal, and the barcode managing module associating the barcode information with the information for distribution; the mobile communication terminal reading the barcode information on the information carrier, and when the barcode information obtained is the same as the barcode information in the barcode managing module, the information for distribution associated with the barcode being partially or fully displayed on the mobile communication terminal through a network; the information distributing server performing statistics on the distribution times of the information for distribution associated with the barcode, and billing according to a pre-set charging table based on the distribution times.

Preferably, in the system of collecting information for distribution with a terminal and billing according to distribution times, the barcode managing module comprises a storage module for storing the barcode information and the information for distribution.

Preferably, in the system of collecting information for distribution with a terminal and billing according to distribution times, the barcode managing module further comprises a matching module for matching the received barcode information to one or more storage records in the information distributing server.

Preferably, in the system of collecting information for distribution with a terminal and billing according to distribution times, the barcode managing module comprises a statistic block for performing statistics on the access times of the information for distribution led by the barcode.

Preferably, in the system of collecting information for distribution with a terminal and billing according to distribution times, the barcode managing module comprises a charging block for setting various charging formulas or tables based on the information distribution times, and calculating the charging result.

Preferably, in the system of collecting information for distribution with a terminal and billing according to distribution times, the mobile communication terminal includes an information reading apparatus.

Preferably, in the system of collecting information for distribution with a terminal and billing according to distribution times, the information reading apparatus is a photoelectric reading apparatus such as a digital camera, a barcode identifying device and the like.

A method of collecting information for distribution with a terminal and billing according to distribution times, comprising the following steps:
step 1, transmitting information to be distributed and barcode information to an information distributing server through an information inputting terminal;
step 2, a barcode managing module associating the barcode information with the information for distribution;
step 3, a mobile communication terminal reading barcode information on an information carrier;
step 4, the mobile communication terminal sending the barcode information to the information distributing server through a network;
step 5, the barcode managing module matching the received barcode information sent by the mobile communication terminal to barcode information stored by its own to determine if they are the same;
step 6, if they are the same, the barcode managing module sending the information for distribution associated with the barcode information to the mobile communication terminal;
step 7, the barcode managing module performing statistics on the distribution times of the information for distribution associated with the barcode information, and billing according to a pre-set charging table based on the distribution times.

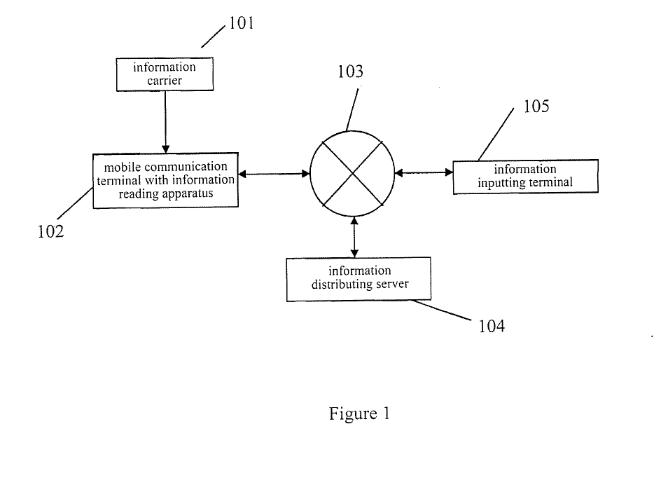

FIG. 1 is a block diagram of the present invention. The information carrier 101 is a codable and auto-identifiable image such as a barcode. In the present invention, an information distributor transmits the information to be distributed and barcode information to an information distributing server 104 through an information inputting terminal 105 via a network 103, and the information distributing server 104 associates the barcode information with the information for distribution by a barcode managing module therein. A user reads the information on the information carrier 101 by a mobile communication terminal 102 with an information reading apparatus. The information obtained by decoding is matched to stored barcode information in the barcode managing module, and if they are the same, the information for distribution associated with the barcode information is partially or fully displayed on the display screen of the mobile communication terminal 102 through the network. The service provider performs statistics on the distribution times of the information for distribution associated with the barcode, and charges according to a pre-set charging table based on the distribution times.

The information reading apparatus is a photoelectric reading apparatus such as a digital camera, a barcode identifying device and the like, which is installed in or connected to the mobile communication terminal. The information reading apparatus may identify the encoded information on the information carrier.

The mobile communication terminal has the function of communication. By the information communication function (for example, browser function) of the mobile communication terminal, the information codes transmitted by the information reading apparatus are sent to the information distributing server via the network. Meanwhile, the mobile communication terminal may also receive information from the information distributing server.

The information distributing server is comprised of: a storage module for storing the barcode information, the information for distribution and so on; a matching module for matching the received barcode information to one or more storage records (for example, multiple pieces of price information corresponding to one barcode) in the server; a statistic block for performing statistics on the access times of the information for distribution led by the barcode; and a charging block for setting various charging formulas or tables based on the information distribution times, and calculating the charging result.

### EXAMPLES

### Example 1

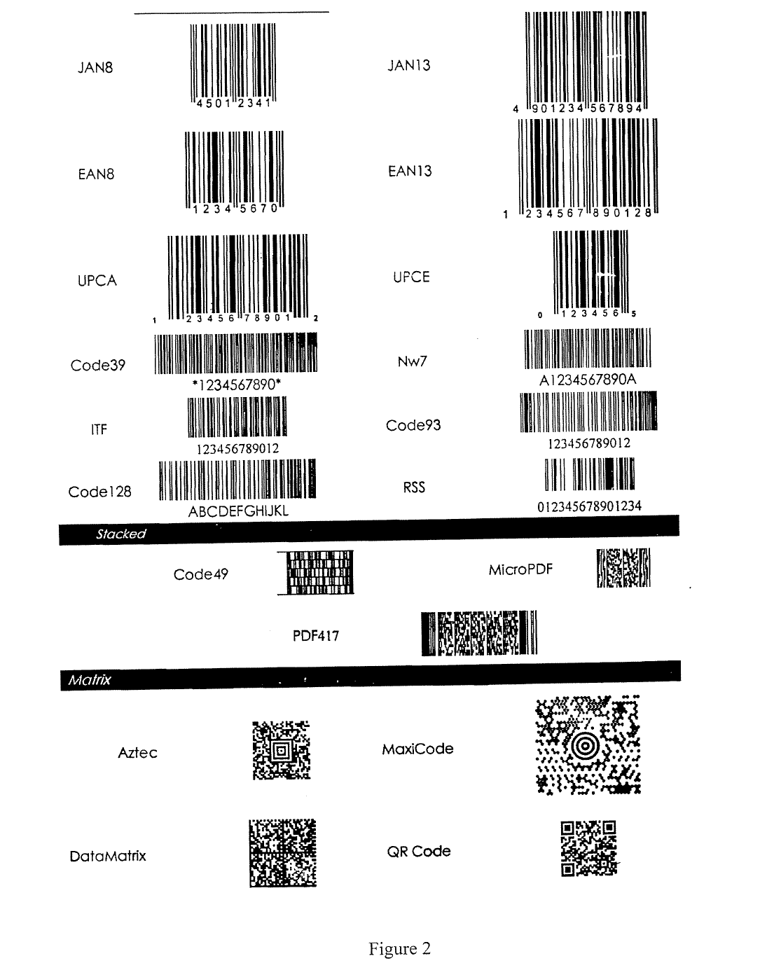

In a system of collecting information for distribution with a terminal and billing according to distribution times in accordance with example 1 of the present invention, a barcode, which includes one dimensional code and two dimensional code, is used as the information carrier. The applicable barcode patterns are shown in FIG. 2. The billing method is the methodology of charging according to equal payments, which is, the cost of each distribution being unchanged despite of distribution times.

As shown in the FIG. 1, a barcode is used as the information carrier 101, and the information distributor transmits the information to be distributed such as ‘sales for the Grapefruit Juice of DAHU Brand, [symbol] 8 (8 Yuan) per bottle’ and the barcode information such as ‘7000123’ to the information distributing server 104 through the information inputting terminal 105 via the network 103. The information distributing server 104 associates the barcode with the information for distribution by the barcode managing module. The user reads the information on the information carrier 101 by the mobile communication terminal 102 with the information reading apparatus. The decoded information (7000123) is matched to the stored barcode information in the barcode managing module, and if they are the same, the information for distribution (‘sales for the Grapefruit Juice of DAHU Brand, [symbol] 8 per bottle’) which is associated with barcode information will be partially or fully displayed on the display screen of the mobile communication terminal 102 via the network. The service provider performs statistics on the distribution times of the information for distribution associated with the barcode (i.e., the times that the users has accessed the information for distribution by scanning the barcode), and charges according to a fixed payment for each distribution (for example, [symbol] 3 per time).

In this example, the associating relationship between the barcode and the information for distribution which are collected through the information inputting terminal is “one to one”. However, as the skilled in the art will recognize that the present invention is not so limited, and other associating mechanism may be employed. Furthermore, associated barcode and information for distribution may be re-associated according to changed associating mechanism with other information/barcode, as needed for specific applications.

### Example 2

In a system of collecting information for distribution with a terminal and billing according to distribution times in accordance with example 2 of the present invention, a barcode, which comprises the one dimensional code and the two dimensional code, is used as the information carrier. The barcode patterns are shown in FIG. 2. The billing method is the methodology of charging according to unequal payments, which is, the cost of each distribution being variable depending on distribution times.

The flow of the information distribution is the same as that of example 1, except that the methodology for charging is different. The methodology of charging according to unequal payments may be any one of the following:

1) The methodology of charging according to descending payments, that is, the payment for each distribution descending as the distribution times increasing, for example: [symbol] 5 per distribution for total distribution times being within 100, [symbol] 4 per distribution for total distribution times being between larger than 100 and not greater than 300, and [symbol] 3 per distribution for total distribution times greater than 300.

2) The methodology of charging according to incremental payments, that is, the payment for each distribution increasing as the distribution times increasing, for example: [symbol] 3 per distribution for total distribution times being within 100, [symbol] 4 per distribution for total distribution times being between greater than 100 and not greater than 300 and [symbol] 5 per distribution for total distribution times greater than 300.

3) The methodology of charging according to progressive descending payments, that is, the payment for each distribution progressively descending as the distribution times increasing, for example: [symbol] 5 per distribution for those distributions when distribution times being within 100, [symbol] 4 per distribution when distribution times being between greater than 100 and not greater than 300, and [symbol] 3 per distribution when distribution times greater than 300. As such, the payment for 500 distributions is: 100×5+200×4+200×3= [symbol] 1900.

4) The methodology of charging according to progressive incremental payments, that is, the payment for each distribution progressively increasing as the distribution times increasing, for example: [symbol] 3 per distribution for those distributions when distribution times being within 100, [symbol] 4 per distribution when distribution times being between greater than 100 and not greater than 300, and [symbol] 5 per distribution when distribution times greater than 300. As such, the payment for 500 distributions is: 100×3+200×4+200×5= [symbol] 2100.

5) The methodology of charging according to a fixed total payment, that is, the total payment being fixed despite of the distribution times.

6) The methodology of a combination of charging according to a fixed payment and charging according to equal payments, that is, the payment being fixed when the distribution times is within a set number, and charging according to equal payments (for each distribution) when the distribution times exceeds the set number. For example, the payment for distributions when the distribution times is within 300 is set to be [symbol] 1000, and when the distribution times exceeds, payment for each distribution is [symbol] 3, as such, if the distribution times is 500, then the total payment is: 1000+200×3= [symbol] 1600.

7) The methodology of a combination of charging according to a fixed payment and charging according to unequal payments, that is, the payment being fixed when the distribution times is within a set number, and charging according to unequal payments as 1) or 2) or 3) or 4) when the distribution times exceeds the set number.

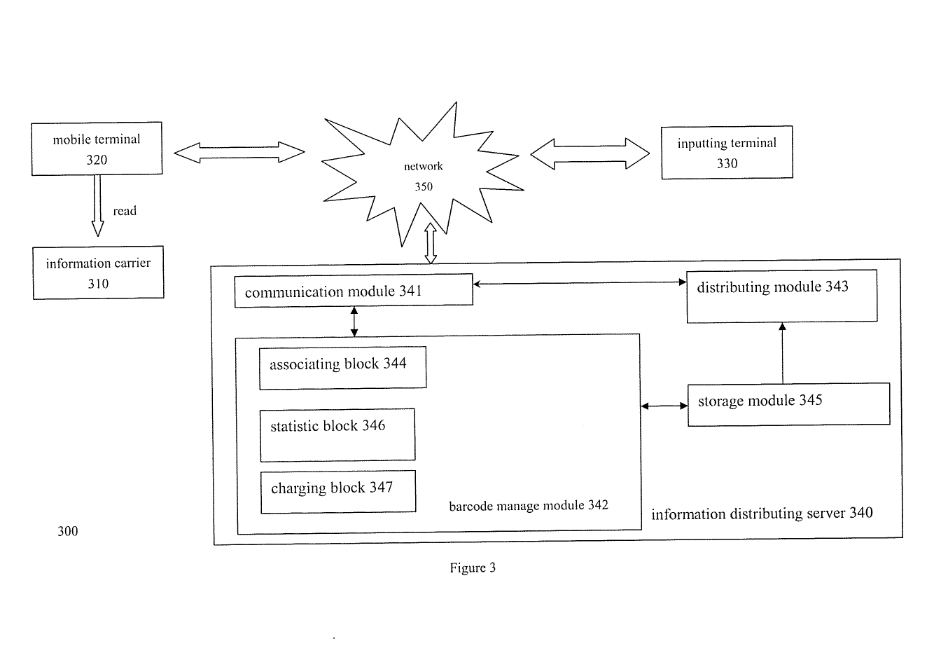

FIG. 3 is a block diagram of a system 300 for collecting information for distribution and billing based on distribution times in accordance with the present invention. As shown in FIG. 3, the system 300 includes an information carrier 310, a mobile terminal 320, an information inputting terminal 330 and an information distributing server 340, which are interconnected as shown in a network 350. By using the information inputting terminal 330, new barcode information and information for distribution may be collected for example from an distributor. The barcode information is encoded into an information carrier (for example, information carrier 310). The carrier 310 may be one-dimensional code, two-dimensional code, multi-dimensional code, colorful barcode and the like, and the present invention is not limited in this aspect. A mobile terminal 320 may read the barcode information on the information carrier, and may send the barcode information to the information distributing server 340 to obtain associated information for distribution. For reading the barcode information, the mobile terminal 320 may be equipped with barcode reading apparatus, which may be a barcode reader, a camera and the like.

As it may be seen from FIG. 3, the information distributing server 340 includes a communication module 341 for communicating via the network 350. For example, the information distributing server 340 may receive the collected barcode information and information for distribution through the communication module 341, or it may communicate with the mobile terminal 320. A barcode manage module 342 may obtain the collected information for distribution and information of barcodes from the communication module 341, and may associating the collected barcode information with the information for distribution through an associating block 344 therein. Furthermore, the associating block may change the associating relationship between existing information of barcodes and information for distribution according to the distributor's requirement. The associating relationship is stored in the storage module 345. It may be stored as look-up table or other forms known in the art. The information distributing server further includes a distributing module 343. When the mobile terminal sends the read barcode information to the information distributing server, the distributing module 343 may determine matching relationship and distributing the information for distribution stored in the storage module 345 according to the matching relationship. This process may incorporate more actions and criteria, and the present invention is not limited in this aspect. For example, in the commonly owned PCT application PCT/CN2005/001780, some other operations are disclosed. The information distributing server further includes a statistic block 346 within the barcode manage module for performing statistic on the distribution times of the information for distribution. The information distributing server may further comprise a charging block 347 within the barcode manage module for performing billing operations. By obtaining the distribution times, the charging block 347 may bill according to a charging mechanism. The charging mechanism comprises one of charging by unequal payments, charging by descending payments, charging by incremental payments, charging by progressive descending payments, charging by progressive incremental payments, charging by a fixed total payment and any combination thereof. Further more, the charging mechanism may be changed or adjusted in real time as desired for specific applications.

All the modules or blocks described above may be implemented in one or a combination of hardware, firmware, and software. Alternatively, the modules and blocks of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others. Although the information distributing server is illustrated as having several separate functional modules or blocks, one or more of the functional modules or blocks may be combined and may be implemented by combinations of software-configured elements, such as processing elements including digital signal processors (DSPs), other hardware elements.

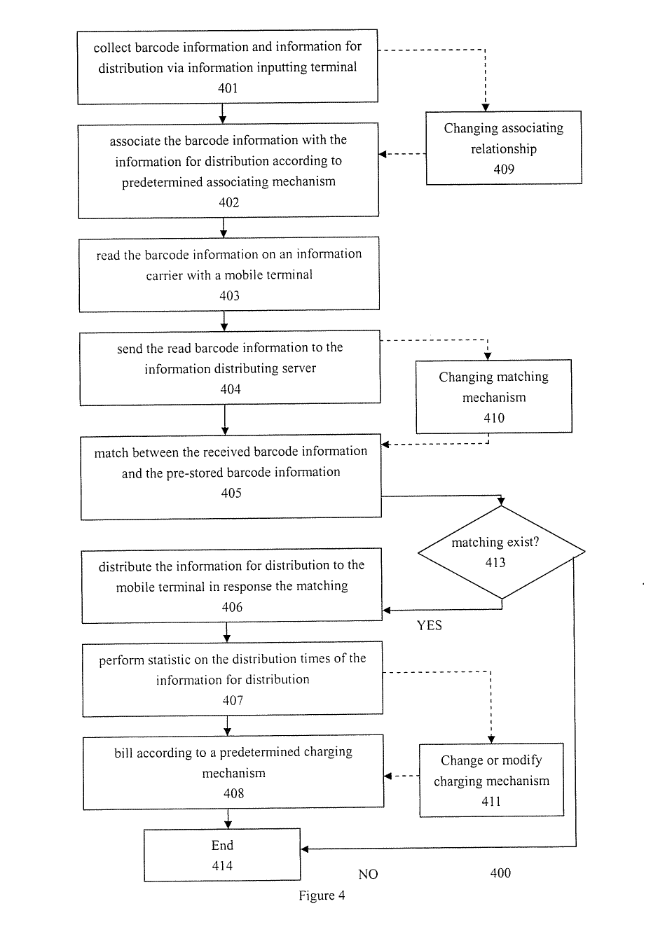

FIG. 4 is a flow chart 400 showing a method for collecting information for distribution and billing based on distribution times in accordance with the present invention. At 401, barcode information and information for distribution may be collected for an information distributing server via an information inputting terminal. Then the barcode information is associated with the information for distribution according to a predetermined associating mechanism (402). The barcode information may be carried on an information carrier such as one-dimensional code, two-dimensional code and the like. The barcode information on the information carrier is read (at 403) with a mobile terminal and is sent (at 404) to the information distributing server. At 405, the received barcode information is matched with pre-stored barcode information. If there is a match (the answer to the decision block 413 is ‘YES’), at 406, in response to the matching, the information for distribution which is associated with the matched barcode information is distributed to the mobile terminal. Otherwise (the answer to the decision block 413 is ‘NO’), the process ends. Proceeding from 406, statistic may be performed (407) on the distribution times of the information for distribution, and payments for information distribution may be calculated (408) according to a predetermined charging mechanism. As mentioned above, the predetermined charging mechanism comprises one of charging by unequal payments, charging by descending payments, charging by incremental payments, charging by progressive descending payments, charging by progressive incremental payments, charging by a fixed total payment and any combination thereof. The process ends at 414. Additionally, in the process 400 of this method, the matching mechanism and the charging mechanism may be changed or modified (at 410 and 411, respectively) for specified application.

Although flow diagrams may have been used herein to describe embodiments, the inventions are not limited to those diagrams or to corresponding descriptions herein. For example, flow need not move through each illustrated box or exactly in the same order as illustrated and described herein. In addition, program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a machine accessible medium having stored thereon instructions that may be used to program a processing system or other electronic device to perform the methods.

The terms and expressions which have been employed herein are used as terms of description and not of limitation, and there is no intention, in the use of such terms and expression, of excluding any equivalents of the features shown and described (or portions thereof), and it is recognized that various modifications, variations, alternatives, and equivalents are possible within the scope of the claims. Accordingly, the claims are intended to cover all such modifications, variations, alternatives, and equivalents.

What is claimed is:

1. A method for collecting information for distribution and billing based on distribution times, the method comprising:
collecting barcode information and information for distribution for an information distributing server via an information inputting terminal;
associating the barcode information with the information for distribution according to a predetermined associating mechanism;
reading the barcode information on an information carrier with a mobile terminal and sending the read barcode information to the information distributing server;
distributing the information for distribution to the mobile terminal in response to a matching between the received barcode information and the pre-stored barcode information which is associated with the information for distribution; and
performing statistic on the distribution times of the information for distribution, and billing according to a predetermined charging mechanism,
wherein the information distributing server, the mobile terminal and information inputting terminal are coupled in a network.

2. The method of claim 1, wherein the operation of associating the barcode information with the information for distribution is performed by an associating block within a barcode manage module in the information distributing server.

3. The method of claim 1, wherein the operation of performing statistic on the distribution times of the information for distribution is performed by a statistic block within a barcode manage module in the information distributing server; and the operation of billing is performed by a charging block within the barcode manage module in the information distributing server.

4. The method of claim 1, wherein the predetermined associating mechanism comprises one-to-one relationship.

5. The method of claim 1, the predetermined charging mechanism comprises one of charging by unequal payments, charging by descending payments, charging by incremental payments, charging by progressive descending payments, charging by progressive incremental payments, charging by a fixed total payment and any combination thereof.

6. The method of claim 1, wherein the barcode is at least one of one dimensional code, two dimensional code, multi-dimensional code and colorful barcode.

7. A system for collecting information for distribution and billing based on distribution times, the system comprising:
an information carrier for carrying barcode information;
a mobile terminal for reading and sending the barcode information on the information carrier;
an information inputting terminal for collecting barcode information and information for distribution for an information distributing serve;
an information distributing server for associating the collected barcode information with the information for distribution according to a predetermined associating mechanism, for distributing the information for distribution to the mobile terminal in response to a matching between the received barcode information and the pre-stored barcode information which is associated with the information for distribution, and for performing statistic on the distribution times of the information for distribution, and billing according to a predetermined charging mechanism,
wherein the information distributing server, the mobile terminal and the information inputting terminal are coupled in a network.

8. The system of claim 7, wherein the information distributing server further comprises an associating block within a barcode manage module for associating the collected barcode information with the information for distribution.

9. The system of claim 7, wherein the information distributing server further comprises a statistic block within a barcode manage module for performing statistic on the distribution times of the information for distribution.

10. The system of claim 7, wherein the information distributing server further comprises a charging block within a barcode manage module for performing the billing operation.

11. The system of claim 7, wherein the predetermined charging mechanism comprises one of charging by unequal payments, charging by descending payments, charging by incremental payments, charging by progressive descending payments, charging by progressive incremental payments, charging by a fixed total payment and any combination thereof.

12. The system of claim 7, wherein the predetermined associating mechanism comprises one-to-one relationship.
